(19) United States
(12) Patent Application Publication
(10) Pub. No.: US 2007/0118664 A1
(43) Pub. Date: May 24, 2007

(54) Mail dispatch system

(75) Inventors: Lucien Mirabeau, Tucson, AZ (US); Tiep Q. Pham, Tucson, AZ (US)

Correspondence Address: QUARLES & BRADY STREICH LANG LLP, 1 SOUTH CHURCH AVENUE, SUITE 1700, TUCSON, AZ, 85701, US

(73) Assignee: International Business Machines Corporation, Armonk, NY (US)

(21) Appl. No.: 11/256,876

(22) Filed: Oct. 24, 2005

(51) Int. Cl. G06F 15/16

(52) U.S. Cl. 709/230

(57) ABSTRACT

A mail dispatch system for a computer subsystem has at least one data processing server. An interface device is configurable to electrically couple to the server. The device has an input/output (I/O) port for sending and receiving information A mail dispatch module is adapted to be operable on the interface device. The module includes a mail dispatch algorithm adapted to identify a first number of data processing servers, identify a second number of I/O ports and calculate an optimal mail dispatch unit based on the first and the second numbers.

### BACKGROUND OF THE INVENTION

1. Field of the Invention

The present invention relates in general to computers and, more particularly, to a system and method of improving performance of mail dispatch in a computer subsystem.

2. Description of the Prior Art

In computer systems, interface devices serve to bridge the physical and logical chasm that separates the central processing unit (CPU) from devices such as storage devices. For example, a host adapter or host buss adapter (HBA) connects a host system (the computer) to other network and storage devices. Interface devices termed host adapters can refer to devices for connecting Fibre Channel and Small-Computer-System-Interface (SCSI) devices, but devices for connecting to Enterprise System Connection (ESCON), Ethernet, and other systems may also be called host adapters. Recently, the advent of Internet SCSI (iSCSI) has brought about Ethernet HBAs, some including Transmission Control Protocol (TCP) Offload Engines.

Interface devices such as host adapters use what is commonly referred to as Mail Protocol as a means of communication between components in a computer subsystem. Mail Protocol provides a mechanism to send and receive mail, which can be defined as information intended for a process running on the adapter. Typically, mail is stored in a buffer located as part of the adapter or in a similar location. Each piece of mail may generate several tasks that are dispatched in what is commonly termed a scan loop. A scan loop is typically entered in a subsystem once the various interfaces of the subsystem are first initialized. In a scan loop involving a host adapter, for example, the adapter analyzes each respective interface to see if any work must be generated.

Through each pass through a mail scan loop, the mail scan loop is typically invoked to dispatch one unit of mail. However, in stress conditions, for example, the mail can accumulate in the buffer and cause performance degradation. Attempts have been made to dispatch multiple units of mail at one time, often with similar performance degradation due to constantly processing units of mail at the expense of other tasks. In an example worst case scenario, the buffer is exhausted and causes an error condition where no new units of mail can be queued in the subsystem.

The topology of interface devices and similar subsystems can change over the course of typical operation of a computer system. Activities from servers and input-output (I/O) ports change continuously. I/O ports may become busy or idle as the workload of a typical computer system changes. In some cases, no activity may occur because of offline maintenance, concurrent codeload or error recovery. An effective way to facilitate mail dispatch which accommodates dynamic changes in a computer subsystem has not yet been realized.

Thus, a need exists for a system and method of facilitating mail dispatch in a computer subsystem which uses a basis such as an algorithm that reflects a particular configuration and topology to maximize performance. In addition, a need exists for a system and method of dynamically recalibrating or adjusting the basis to incorporate the state and activities in the computer subsystem.

### SUMMARY OF THE INVENTION

In one embodiment, the present invention is a mail dispatch system for a computer subsystem having at least one data processing server, comprising an interface device configurable to electrically couple to the server having an input/output (I/O) port for sending and receiving information, and a mail dispatch module adapted to be operable on the interface device, wherein the module includes a mail dispatch algorithm adapted to identify a first number of data processing servers, identify a second number of I/O ports and calculate an optimal mail dispatch unit based on the first and the second numbers.

In another embodiment, the present invention is a method of mail dispatch in a computer subsystem having Task Control Blocks (TCBs), comprising identifying first and second configurations taken at first and second predetermined times, the first and second configurations representative of a number of active servers and a number of active input/output (I/O) ports of the computer subsystem, and comparing the first and second configurations, wherein if the first configuration differs from the second configuration the method further includes initializing a dispatch unit to a first value representative of the number of active servers in the computer subsystem, initializing a maximum dispatch unit to a second value representing the number of active servers and the number of active input/output (I/O) ports, identifying a first number of active TCBs and setting a dispatch unit to the first value.

In still another embodiment, the present invention is a computer program product usable with a programmable computer processor having a computer readable program code embodied therein, comprising computer readable program code which identifies first and second configurations of a computer system at first and second predetermined times, computer readable program code which initializes a minimum dispatch unit representative of a number of active servers in the computer system, computer readable program code which initializes a maximum dispatch unit representative of the number of servers and a number of active input/output (I/O) ports in the computer system, computer readable program code which identifies first and second numbers of active Task Control Blocks (TCBs), computer readable program code which compares the first configuration with the second configuration and computer readable program code which calculates an optimal dispatch unit using a mail dispatch algorithm.

### BRIEF DESCRIPTION OF THE DRAWINGS

FIG. 1 illustrates an example computer system;

FIG. 2 illustrates an example method of automatic calibration of a mail dispatch system to maximize performance.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

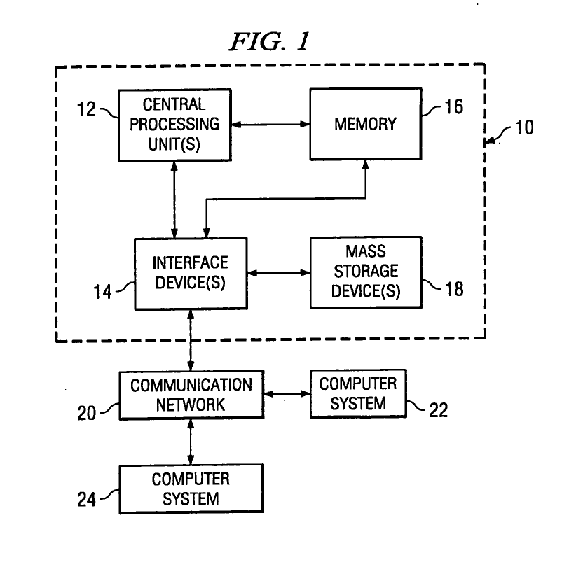

Turning to FIG. 1, an example computer system is depicted. Computer 10 includes one or more central processing units (CPUs) 12. CPU 12 is electrically coupled to one or more interface devices 14. Computer 10 also includes onboard memory 16 and one or more mass storage devices 18. Interface device 14 is linked to communication network 20, which can include such conventional technology as Ethernet or a wireless equivalent (IEEE 802.11b or similar). Communication network 20 is shown linked to external computer systems 22 and 24.

Computer 10 can include a data processing server which uses any known combination of hardware and operating software to effect data processing tasks which are performed by CPU 12 or elsewhere in computer 10. Interface device 14 can include such hardware as common host adapters. Additionally, interface device 14 can be adapted to be compatible with such computing specifications as Small-Computer-System-Interface (SCSI), Enterprise System Connection (ESCON), Fibre Channel, and the like. A second data processing server can be located as part of CPU 12, located as part of a second CPU 12 or elsewhere in computer 10.

A typical operation of data processing server can involve processing steps required to authenticate a password received from a remote source. For example, a holder of a bank account wishes to access the account online to view a recent banking transaction. A data processing server acting as a gateway can cause computer 10 to assemble a login screen with pertinent information and data fields such as an identification number and relevant password. After presenting the user with the login screen, the user can enter a respective identification number and appropriate password. The login data can be sent over external computer system 22, through communication network 20 into computer 10. The data is received through an Input-Output (I/O) port located as part of interface device 14.

The relevant password data can be converted into a “unit” of mail. A typical login sequence can involve a gateway data processing server requesting the login information, with accompanying instructions for interface device 14 to pass the login information to a password data processing server where the login information can be authenticated. The password data processing server also can instruct interface device 14 to retrieve saved login information located as part of mass storage device 18 to compare the two passwords. Again, the retrieved password data from mass storage device 18 can be converted into a unit of mail to be passed from interface device to the password data processing server.

Another example of mail can involve a spreadsheet program and word processing program which are concurrently operating in a computer system. If the relevant interfaces between the spreadsheet program and the word processing program are understood, an interface device 14 can be used to package content to provide for communication between the programs. In general, the processing of mail by interface device 14 involves transactions such as previously described where high level commands are executed to provide for the transfer of information within a computer subsystem.

As mentioned previously, interface device 14 can have various I/O ports associated with interface device 14. Because an interface device 14 can have several I/O ports, and due to typical I/O load, it might be expected that if multiple ports are present in a computer subsystem, performance (mail dispatch in particular) would correspondingly increase. Based on current methods of mail dispatch, however, subsystem performance has not dramatically improved partly due to the fact that usually one unit of mail is dispatched at any particular time in the subsystem.

The computer subsystem as previously described can make use of so called tasks (threads). A thread is a task that runs concurrently with other tasks within a single executable file (e.g., within a single MS-DOS EXE file). Unlike processes, threads have access to common data through global variables. In a strict sense, multi-tasking cannot occur on a single CPU 12, and, therefore, multi-tasking must be simulated by sharing CPU 12 time between different tasks. Time can be shared between tasks through cooperation, time-slicing, preemption or any combination of the above. Time-sharing techniques have one thing in common: the techniques require the ability to switch from one task to another (context switching).

Tasks, like subroutines, cannot share a common stack. To illustrate, consider a multi-tasking system that erroneously uses a single stack. Consider taskA which is currently nested 2 subroutine calls deep (subX was called which called subY). taskA is now switched out to run taskb, which calls subZ. subZ control is switched back to taskA, which was in subY. When subY attempts to return to subX, an error will occur, as subY will not return to subX because subZ's return information was put onto the stack by taskB. A possible solution is for each task to have an associated stack. In the above example, when control is switched from taskb back to taskA, the stack would also be switched back to taska's stack, and subY will return to subX as it should.

Before switching from taskA to taskB, all information necessary to resume taskA must be saved. The information (the task's context) that must be saved is (1) the address of the instruction at which execution should resume, (2) the CPU flags, (3) all registers, and (4)the stack pointer. The information must be saved because the information will change when control is switched to taskb. An example method to save the information is to create a structure for each task, commonly referred to as the Task Control Block (TCB). Before switching out taskA, all of the context of taskA could be saved in the TCB of taskA. Then, the context from taskB could be restored from the TCB of taskB, which will correspondingly restore the CPU flags, registers, and stack of taskB by changing the stack pointer.

TCBs can be considered active when an associated task is being performed. The term active as used herein can reflect the level of Input/Output activity through an interface device 14 such that the more Input/Output activity, the more active, and the less Input/Output activity, the less active the subsystem. An active TCB can be associated with each Input/Output operation which is occurring in the subsystem.

Given the previously described examples and properties of computer 10 and the associated computer subsystem of computer 10, a system of mail dispatch can be implemented which results in a marked improvement in performance. Specifically, a mail dispatch module can be adapted to be operable on interface device 14. The mail dispatch module can include a functioning dispatch algorithm which is intended to calculate an appropriate mail dispatch unit to be employed by interface 14 as part of a scan loop.

Through observation, a direct relationship is seen between the number of I/O ports and the number of data processing servers which are in operation in a computer system to realize the mail dispatch process. A mail dispatch algorithm operable as part of the mail dispatch module can take into account the relationship between I/O ports and data processing servers.

In general, the dispatch algorithm can be based on the number of I/O ports supported by interface device 14. If interface device 14 has only a single I/O port, a certain number of mail units (M) can be expected to be generated as a result of I/O activity through the single port. If interface device 14 has a corresponding plurality or number (N) of ports, approximately up to M*N number of mail units can be reasonably expected to be generated. Again, as before, the number of units of mail can be expected to increase as the number of ports increases. By dispatching mail faster, more tasks are able to be handled and therefore more I/O activity per second. When mail dispatch is slower, tasks take longer to complete, and, in some cases, the tasks timeout.

To realize the most efficient number of mail dispatch units, the dispatch algorithm can be configured according to
Unit(s)=K+K*N (1),
where Unit(s) describes the appropriate number of units of mail to be dispatched in each scan loop, K describes the number of data processing servers identified by the mail dispatch module, and N describes the number of I/O ports on interface device 14.

As an example calculation, in a computer system including two (2) data processing servers and one interface device 14 having four (4) I/O ports, the appropriate dispatching unit would be 10 mail. Equation 1 can also be expressed as
Unit(s)=K(1+N) (2),
where again Unit(s) describes the mail dispatch units, K describes the number of data processing servers and N describes the number of I/O ports.

Using a testcase that constrains the CPU 12 resources on interface device 14, and also by performance measurements on current computer 10 equipment, a roughly twenty (20) percent improvement in the number of operations per second in a two-port interface device 14 can be seen. However, the results seen are even more dramatic in configuration with additional I/O ports. The two-port interface device configuration also results in no mail-buffer-available errors (errors which result from no mail slot available to the queue).

During subsystem operation, the activities from the data processing servers and I/O ports can change continuously. While a fixed algorithm is generally effective and adequate as employed by a mail dispatch module, a fixed algorithm may not be the ideal solution in a changing environment. Again, as previously described, there may be no activity in the subsystem because the path has been varied offline for maintenance or due to concurrent codeload or error recovery. Additionally, the data processing servers may also reflect little or no activity at times.

To efficiently determine an optimal mail dispatch unit under changing conditions, a method can be utilized, again using a mail dispatch module or similar device to effectuate a dispatch algorithm, to increase subsystem performance. The method can allow the subsystem to run at peak performance regardless of the I/O load by continually recalibrating the mail dispatch algorithm to match the current demand on the subsystem. The performance of the subsystem becomes more reliable because the subsystem adapts dynamically to changes in the subsystem configuration and environment.

To implement an example method as described below, a system can be assumed to consist of K number of servers and multiple interface devices 14 with I/O ports where N defines the number of active I/O ports. Again, an active number of TCBs can be associated with interface device 14 to describe the level of I/O activity in the subsystem.

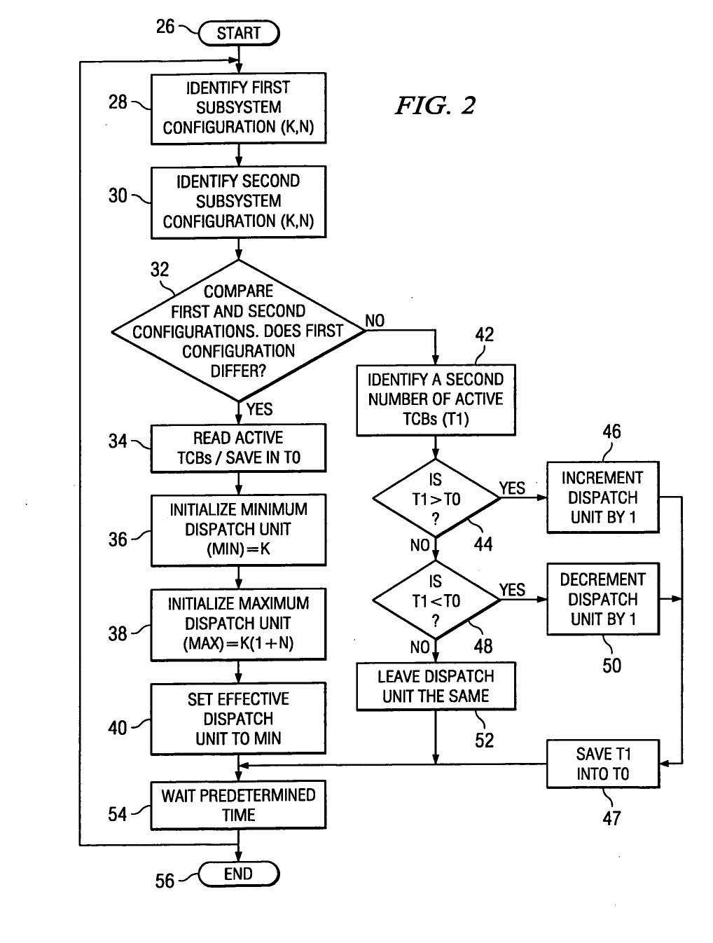

Turning to FIG. 2, an example method A of performing mail dispatch in a dynamic environment is illustrated. Step 26 begins the process. A first subsystem configuration is identified in step 28. The subsystem configuration can be a unique number (K,N) where K is the number of active servers and N is the number of active ports. If a first subsystem configuration has already been read, step 28 is bypassed. A second subsystem configuration is identified in step 30 at a later time. The second subsystem configuration is compared in step 32 with the first subsystem configuration or the last configuration read. Note that the first time through a scan loop the configuration number is (0,0).

If the second configuration differs from the first configuration or last configuration read, the active number of TCBs is read and saved in TO as step 34. A minimum mail dispatch unit (Min) is initialized to value K in step 36. A maximum mail dispatch unit is initialized (Max) to value K(1+N) in step 38, reflecting a contribution from the static mail dispatch algorithm seen in equation (2) previously. An effective mail dispatch unit is set to equal the minimum mail dispatch unit in step 40.

If the second configuration does not differ from the first configuration or last configuration read, a second number of active TCBs is identified in step 42 and saved as (T1). A comparison step 44 determines whether T1>T0. If yes, the effective dispatch unit is incremented by one unit in step 46. Following step 46, the second number of active TCBs (T1) is saved into T0 in step 47. If the query of step 44 returns no, a comparison step 48 determines whether T1<T0. If yes, the effective dispatch unit is decremented by one unit in step 50. If the query of step 48 returns no, the effective dispatch unit is left the same in step 52. Again, following step 50, step 47 saves T1 into T0. Steps 40, 47 and 52 lead to step 54, where the process waits a predetermined time before returning again to step 28. Step 54 can establish a time period which executes the example method A for every number (X) of scan loops. For example, example method A can execute every 100 scan loops in order to minimally effect performance of the subsystem. Step 54 can be determined systematically in order to minimize the effect of example method A on the subsystem and maximize performance.

A mail dispatch module, or the example method A previously described, can exist as instructions for computer 10 which are stored as part of memory 16, mass storage 18 or found on a compact-disk (CD), downloadable from a web site or similar computer program product medium.

While one or more embodiments of the present invention have been illustrated in detail, the skilled artisan will appreciate that modifications and adaptations to those embodiments may be made without departing from the scope of the present invention as set forth in the following claims.

What is claimed is:

1. A mail dispatch system for a computer subsystem having at least one data processing server, comprising:
an interface device configurable to electrically couple to the server, the device having an input/output (I/O) port for sending and receiving information; and
a mail dispatch module operable on the interface device, wherein the module includes a mail dispatch algorithm for identifying a first number of data processing servers, identifying a second number of I/O ports, and calculating an optimal mail dispatch unit based on the first and the second numbers.

2. The system of claim 1, wherein the mail dispatch algorithm is configured according to:
U=K(1+N),
wherein U is a unit of mail dispatched by the subsystem, K represents the number of data processing servers, and N is the number of I/O ports in the interface device.

3. The system of claim 1, wherein the interface device comprises a host adapter.

4. The system of claim 1, wherein the mail dispatch module is configurable to operate during a scan loop of the interface device.

5. The system of claim 1, wherein the interface device is compatible with a Small-Computer-System-Interface (SCSI) type specification.

6. The system of claim 1, wherein the interface device is compatible with an Enterprise System Connection (ESCON) type specification.

7. The system of claim 1, wherein the interface device is compatible with a Fibre Channel type specification.

8. A method of mail dispatch in a computer subsystem having Task Control Blocks (TCBs), comprising:
identifying first and second configurations taken at first and second predetermined times, the first and second configurations being representative of a number of active servers and a number of active input/output (I/O) ports of the computer subsystem; and
comparing the first and second configurations, wherein if the first configuration differs from the second configuration the method further includes
initializing a minimum dispatch unit to a first value representative of the number of active servers in the computer subsystem,
initializing a maximum dispatch unit to a second value representing the number of active servers and the number of active input/output (I/O) ports,
identifying a first number of active TCBs, and
setting an effective dispatch unit to the first value.

9. The method of claim 8, further including comparing the first and second configurations, wherein if the first configuration does not differ from the second configuration the method further includes
identifying a second number of active TCBs,
incrementing the effective dispatch unit if the first number of active TCBs is less than the second number of active TCBs,
decrementing the effective dispatch unit if the first number of active TCBs is greater than the second number of active TCBs.

10. The method of claim 8, wherein the first predetermined time is chosen to coincide with a predetermined number of executed scan loops.

11. A computer program product usable with a programmable computer processor having a computer readable program code embodied therein, comprising:
computer readable program code which identifies first and second configurations of a computer system;
computer readable program code which initializes a minimum dispatch unit representative of a number of active servers in the computer system;
computer readable program code which initializes a maximum dispatch unit representative of the number of servers and a number of active input/output (I/O) ports in the computer system;
computer readable program code which identifies first and second numbers of active Task Control Blocks (TCBs);
computer readable program code which compares the first configuration with the second configuration; and
computer readable program code which calculates an optimal dispatch unit using a mail dispatch algorithm.

12. The computer program product of claim 11, wherein the mail dispatch algorithm includes values representative of the number of active servers, the number of active I/O ports and the first and second numbers of active TCBs in the computer system.

13. The computer program product of claim 10, wherein if the first and the second configurations differ, the maximum dispatch unit is initialized according to:
(Max)=K(1+N)
wherein (Max) is the maximum dispatch unit, K is the number of active servers and N is the number of active I/O ports.

14. The computer program product of claim 10, wherein if the first and the second configurations are equivalent the optimal dispatch unit is modified based on a comparison between the first and the second numbers of active TCBs in the computer system.
